(19) United States
(12) Patent Application Publication
(10) Pub. No.: US 2017/0158334 A1
(43) Pub. Date: Jun. 8, 2017

(54) MODULAR RAIL SYSTEM FOR FASTENING OF FURNISHING ITEMS TO A FLOOR OF A VEHICLE CABIN

(71) Applicant: Airbus Operations GmbH, Hamburg (DE)

(72) Inventor: Carsten WOLGAST, Hamburg (DE)

(21) Appl. No.: 15/437,062

(22) Filed: Feb. 20, 2017

Related U.S. Application Data
(63) Continuation-in-part of application No. 15/360,031, filed on Nov. 23, 2016, now abandoned.

(30) Foreign Application Priority Data
Nov. 26, 2015 (DE) 102015120515-7

(51) Int. Cl. B64D 11/06

(52) U.S. Cl. CPC B64D 11/0696; B64D 11/0693

(57) ABSTRACT

A system for fastening items to a floor of a passenger cabin of an aircraft has an elongate support bar having a first main extension direction, a base surface for fastening to a structure of the aircraft, a contact surface extending at a distance to the base surface and having a first width and first connection means, which are distributed along the first main extension direction. The system has an elongate functional attachment having a second main extension direction and a second width, which is equal to the first width at a maximum, and second connection means, which are distributed along the second main extension direction, and connection elements for connecting the functional attachment to the contacting surface of the support bar. The connection elements are adapted for connecting the first and second connection means with each other.

### CROSS-REFERENCE TO RELATED APPLICATION

This application is a continuation-in-part of U.S. patent application Ser. No. 15/360,031, filed Nov. 23, 2016.

### TECHNICAL FIELD

The invention relates to a rail system for fastening of furnishing items to a floor of a vehicle cabin as well as a vehicle cabin having a vehicle structure, a cabin created therein having a floor as well as a rail system installed therein.

### BACKGROUND

Rail systems for fastening of furnishing items in a cabin of a vehicle are known for a long time. Usually, rails are installed substantially along a longitudinal extension of the respective vehicle cabin in a floor region and preferably provide grid openings, which are engageable with suitable arresting devices. The furnishing items to be fastened are connected to the arresting devices and rest upon a surface of the rails. Through using of grid openings, a largely free positioning of the furnishing items is possible. For this purpose it is common to equip substantially the whole floor of the cabin with seat rails that run parallel to each other.

Depending on the desire of the operator of the vehicle it may be intended that rails installed in some regions of the floor are not required. It is common that in this case the grid openings are covered such that they are protected from contamination and damaging. At the same time, the weight of the vehicle is increased due to the permanent installation of the rails even if not all regions of the rails are required.

The integration of such rails into a vehicle also includes a partial absorption of structural loads through the rails, such that they also constitute an integral component of the vehicle structure. The removal of rails from the vehicle, in particular in case the vehicle is realized as an aircraft, is undesirable and, furthermore, almost impossible at a later time.

### BRIEF SUMMARY

Consequently, it is the object of the invention to provide a rail for fastening of furnishing items in a cabin of a vehicle, which is particularly advantageous regarding the weight and also allows an adaption to intended furnishing items without requiring a partial removal of a rail.

The object is met by a rail system having the features of independent claim 1. Advantageous embodiments and further improvements may be gathered from the sub-claims and the following description.

A rail system for fastening of furnishing items to a floor of a passenger cabin of an aircraft is proposed, the rail system comprising at least one elongate support bar having a first main extension direction, a base surface in the form of a first flange, extending along the first main extension direction for fastening to a vehicle structure, a contact surface extending along the main extension direction at a distance to the base surface and having a first width and first connection means, which are distributed along the first main extension direction at a second flange; at least one elongate functional attachment having a second main extension direction and a second width, which is equal to the first width at a maximum, and second connection means, which are distributed along the second main extension direction; and connection elements for connecting the functional attachment to the contacting surface of the support bar. The first and second connection means are arranged corresponding with each other in case the first and second main extension direction coincide. The connection elements are further adapted for connecting the first and second connection means. At least the second flange is formed in a surface like manner.

Consequently, the rail system is a system, which provides a rail for fastening a furnishing item in a passenger cabin of an aircraft, wherein the rail substantially consists of two main components. The first component, which is practically hardly visible in its installed state, is the elongate support bar. This may correlate with a region of a floor or seat rail, respectively, that faces away from an upper side and comprise a profile cross-section, which is able to absorb large bending stresses in the contacting surface. For this purpose, the support bar may exemplarily comprise at least one web, which extends between the base surface and the contacting surface and provides for an appropriate geometrical moment of inertia. In a most simple case, the support bar may thus comprise a double-T-structure. The section of the support bar that provides the contacting surface, is realized as a surface-like flange. It may also be reasonable to form the section of the support bar that provides the base surface, as a surface-like flange.

Usually, those parts of a beam that are designed to be flat, even or planar and that are arranged in a distance to each other and that are connected to each other, are referred to as flanges. Sometimes, also the terms “girth” or “belt” are used. The use of surface-like flanges in a distance to each other leads to a particular flexural rigidity, depending on the distance of the flanges to each other and to a particular simple construction. Referring to the installation into the passenger cabin the first flange is a bottom flange, while the second flange is a top flange.

The surface-like design of the flanges means that the profile cross-section of the respective flange perpendicular to the main extension axis of the respective belt is substantially linear or at least comprises a clearly larger width, e.g. parallel to a floor level, than a height, e.g. perpendicular to the floor level. A flange may comprise minor changes in the contour that in its profile cross section, which may relate to the integration of guiding edges or other features in the height direction.

In this regard, the main extension directions are to be considered coinciding in case the support bar and the functional attachment arranged thereon run parallel to each other and are placed relative to each other in a spatial respect, that a connection between both components is providable and that the intended use is facilitated. This may occur in case the functional attachment comprises a second main extension direction, which runs directly vertically above the first main extension direction and axes created along the main extension direction have a predetermined use distance to each other.

The support bar is intended for being permanently integrated into the vehicle structure, such that the base surface or the first flange, respectively, is permanently connected with the vehicle structure. In doing so, no modifications to an already designed vehicle structure, that is certified for operation is required, the support bar fulfils the same purpose as seat or floor rails known from the prior art. Particularly advantageously, the support bar itself may be similar to and mechanically equivalent with a floor rail, which is certified for operation in the respective aircraft, without, however, comprising the usual devices for fastening of passenger seats.

The special advantage of the rail system lies in the selective use of different functional attachments, which are adapted to a locally desired function or which may be omitted completely. Thus, in case a region of the floor in the cabin is not to be equipped with furnishing items, the functional attachment may be omitted completely in this region, which offers a clear weight advantage compared with full seat or floor rails.

The functional attachment may, as clarified above, be designed arbitrarily, as long as its “second” width equals the “first” width at a maximum and thus allows the functional attachment to rest on it completely.

The contacting surface may also be merely a section of an upper delimiting surface or second flange, respectively, which is intended for receiving a functional attachment. In this regard it should be considered, that a rail produced by the rail system according to the invention may also comprise one or two horizontal webs, which extend along the first main extension direction for laying of floor plates or the such thereon. The above-mentioned contacting surface may hence be understood as a partial section of the surface on the second flange facing into the cabin, which exemplarily is created between two such webs or which is adjacent to a single such web.

The first and second connection means may be designed arbitrarily, such that a connection of both connection means with each other is facilitated, such that a sufficient transfer of forces and moments from the functional attachment into the support bar and vice versa is facilitated. All common connection means and connecting methods that form their basis are possible. It particularly suggests itself to use force- and form-fitting connection elements, which may be loosened without much effort. This particularly refers to screws and bolts.

To sum up, a great weight and flexibility advantage is achieved through the rail system according to the invention compared to known seat or floor rails, particularly for use in an aircraft.

It is advantageous if two surface-like webs, which run parallel to the contacting surface and to each other, are laterally created on the second flange and create lateral guiding edges for delimiting the contacting surface. The exact positioning of a functional attachment before its fastening and the mounting of floor plates on the support bars may thereby be facilitated and improved, respectively.

In an advantageous embodiment, the functional attachment is chosen from a group of functional attachments, the group comprising:

a seat rail attachment having a bottom side and a top side, wherein the bottom side is connectable to the contacting surface of the support bar and wherein the top side comprises grid openings at a distance to each other, and

a floor attachment, whose second width substantially equals the first width, wherein the floor attachment is walk-on-able by persons in the cabin.

In combination with the support bar, the seat rail attachment leads to a common seat rail, onto which seat rail passenger seats and larger furnishing items (also known as monuments) are mounted, in particular in commercial aircraft. Depending on the type and design of the passenger seats, single seats or whole groups may be arranged on two parallelly extending seat rails. If particularly in a region comprising passenger seats, a rather large distance between seat rails is required, support bars are not required for creating of seat rails arranged therebetween. These may then be covered by floor attachments. Such a floor attachment may be understood as a plate-shaped, elongate component, which is usually used for constructing a floor. In particular, in commercial aircraft, these are plates with a lightweight construction having a honeycomb core, which is enclosed by two covering plates. Such floor attachments are to be designed in a manner, such that it can be stepped on by persons, without suffering a damage. For such a design of the floor attachment it suggests itself to conduct a gluing with the support bar, e.g. by means of a double-sided adhesive tape, in case of low mechanical bending and shear stress. In this case, the first connection means would merely be a suitable receiving surface, while the second connection means would be the double-sided adhesive tape. In particular in commercial aircraft, floor plates are typically fixedly screwed, such that an additional stabilization of the fuselage is accomplished through the floor plates. Resultantly, also a floor attachment may be screwed into the support bar, such that the first connection means may e.g. be a threaded hole, the second connection means a through-hole and the connection element a screw or the such.

However, in addition to both these functions, a plurality of other functions is conceivable and reasonable. For example, it is advantageous to use a raceway as functional attachment, which comprises a bottom side and a hollow space defined thereon for receiving and guiding of lines, wherein the bottom side is connectable to the contacting surface of the support bar or the second flange, respectively. With common equipment of the cabin with seat or floor rails the integration of raceways is solved in a manner that raceways are arranged underneath a floor or adjacent to the seat or floor rails, which increases the weight in relation to the solution according to the invention on the one hand, and clearly increases the integration effort on the other hand. Depending on the cables or lines, respectively, to be used, very slim raceway attachments may be used flushly with the floor, without increasing the weight in comparison to a common seat or floor rail. By using a raceway attachment made of a plastics material, also a decrease of weight may be achieved.

In an advantageous embodiment, the group may further comprise a glide rail attachment having a bottom side and a top side, wherein the top side comprises a gliding body, which is adapted for slidably supporting a gliding block along the second main extension direction. For reconfiguration of a passenger cabin it is known to slidably support furnishing items along seat or floor rails and to attach them in grid openings. For facilitating such a displacement, such a glide rail attachment may be used, such that a respective gliding block is movable along the first or second main extension direction easily. The design of the gliding body is largely arbitrary and may be based on a gliding guide as well as on a linear guide comprising rolling elements.

For preventing a lift-off of the gliding block from the glide rail attachment, the glide body may comprise at least one undercut, which extends along the second main extension direction and which is shaped corresponding to a protrusion of the gliding block. In a simple case, the glide body may comprise a T-shaped structure with horizontal webs, wherein correspondingly shaped protrusions may engage under the webs.

The contacting surface of the support bar may comprise at least one guiding means for aligning the functional attachment. In case a free arrangement of a functional attachment on the (larger) contacting the surface of the support bar, e.g., centrally on the second flange of the support bar, is considered, a very precise alignment of the functional attachment on the contacting surface may be required, such that distances between functional attachments of neighboring support bars may be maintained precisely. For reducing the effort that goes therewith, a guide means may be present, which clearly facilitates the alignment. A precise positioning in particular of a seat rail attachment is thereby conductable quickly and without further ado.

The at least one guide means may exemplarily comprise two opposed guiding edges that run along the first main extension direction and that conduct a form-fitting connection with the functional attachment. The guiding edges may particularly be used for laterally delimiting the contacting surface. The functional attachment may thus be inserted between the guiding edges. Furthermore, it is also possible that the guiding edges only comprise a negligible extension away from the contacting surface, such that the functional attachment, e.g. at its bottom side, comprises only a slight thickening, which allows a perceptible, light alignment on the guiding edges.

In an advantageous embodiment, the second connection means may be designed as through-holes. The through-holes allow the insertion of connection elements from a cabin through to the support bar.

The first connection means may furthermore comprise boreholes, which have an inner thread, into which connection elements having an outer thread are screwable, which are inserted through the second connection means.

The at least one functional attachment may be made from a different material than the support bar. In particular when using a floor attachment, another material than for the support bar is used. However, it may also be intended for regions faced with higher loads to manufacture a seat rail attachment or a glide rail attachment from a highly rigid aluminum or titan alloy, the rigidity of which exceeds the one of the support bar. In particular, when using titan, both the spatial extension as well as the weight may be reduced in comparison to common seat or floor rails. For reducing the manufacturing costs, it may be considered to equip the functional attachment with a profile that is simpler to manufacture. Additionally, the functional attachment is resistant to oxidation and therefore does not need to be coated or painted.

The invention furthermore relates to an aircraft, comprising an aircraft structure, a passenger cabin created therein, the cabin having a floor, a plurality of support bars, which are arranged at a vehicle structure that carries the floor as well as functional attachments mounted to the support bars. The support bars and the functional attachments are made with a rail system according to the above description. The functional attachments substantially flushly close off with a floor arranged adjacent thereto.

### BRIEF DESCRIPTION OF THE FIGURES

Other characteristics, advantages and potential applications of the present invention result from the following description of the exemplary embodiments illustrated in the figures. In this respect, all described and/or graphically illustrated characteristics also form the object of the invention individually and in arbitrary combination regardless of their composition in the individual claims or their references to other claims. Furthermore, identical or similar objects are identified by the same reference symbols in the figures.

FIGS. 1a and 1b each show an exemplary embodiment of a support bar.

FIGS. 2a to 2d show different functional attachments.

FIG. 3 shows an exemplary integration of rails into a cabin of an aircraft.

FIG. 4 shows an aircraft having a cabin shown in FIG. 3.

### DETAILED DESCRIPTION OF EXEMPLARY EMBODIMENTS

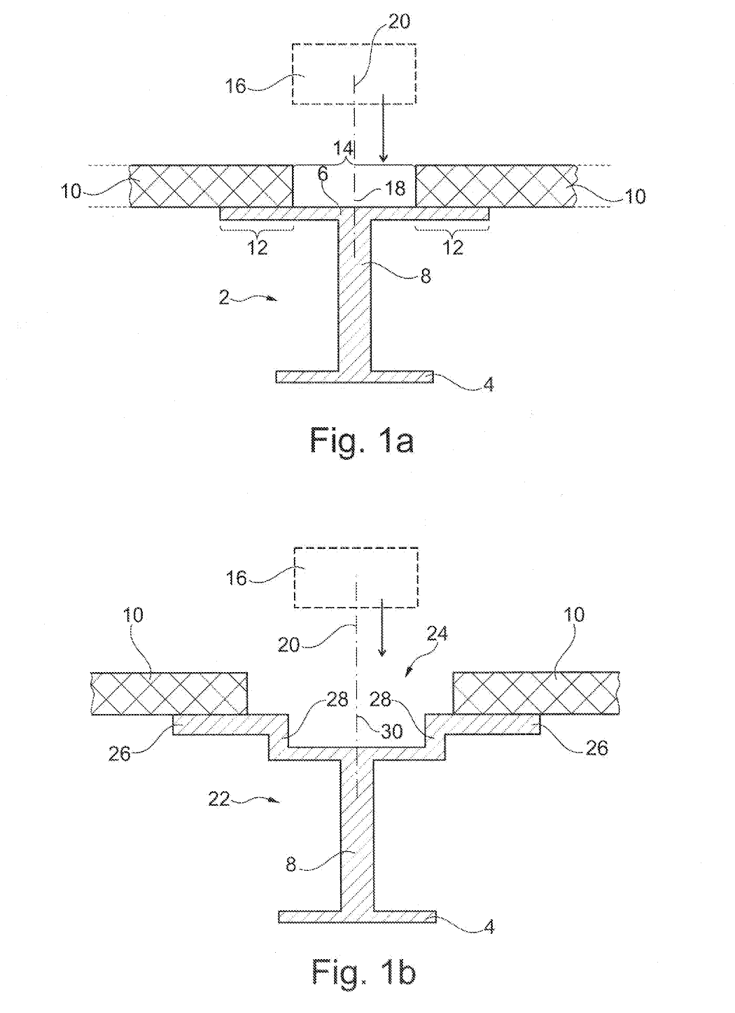

FIG. 1a shows a first exemplary embodiment of a support bar 2 having a base surface 4, which is realised in form of a completely surface-like, flat first flange, a contacting surface 6 at a distance thereto and parallelly arranged in the form of a second flange as well as a web 8 that connects both surfaces. Exemplarily, hereby a double-T-profile cross-section with two flanges and a web is created, wherein the base surface 4 exemplarily only extends about roughly half the distance in lateral directions as the contacting surface 6.

The contacting surface 6 inter alia serves to lay-on floor plates 10 and to fix them on the contacting surface 6, e.g. through screwing. For this purpose, first connection sections 12 are created on the contacting surface 6, which should be reserved for the floor plates 10. Furthermore, the contacting surface 6 comprises a second connection section 14, which is arranged between the first connection sections 12 and which may be occupied by a functional attachment 16, which is shown merely rather schematic by means of a dashed box in FIG. 1.

For connecting the contacting surface 6 exemplarily comprises first connection means 18, which are also relatively schematically illustrated by means of a dashed dotted line. These first connection means 18 may be threaded holes or other form- and/or force-fitting receiving elements. Corresponding second connection means 20 are arranged at the functional attachment 16. The special feature of this exemplary embodiment lies in the continuously flat design of the contacting surface 6.

A slight modification is shown in FIG. 1b in form of a support bar 22. The support bar 22 also comprises a base surface 4 as well as a web 8, but a contacting surface 24 as part of a second flange is delimited by two lateral webs 26 that run parallel to the contacting surface 24 and that supplement the second flange laterally, such that guiding edges 28 are arranged at both sides of the contacting surface 24. Altogether, the second flange comprises a substantially surface-like shape through the connection of three surface-like elements. A functional attachment 16 having second connection means 20 may resultantly be positioned on the contacting surface 24 between the guiding edges 28, in order to be connected with first connection means 30 there. Laterally outer webs 26 exemplarily exclusively serve for receiving of floor plates 10, as already shown in FIG. 1.

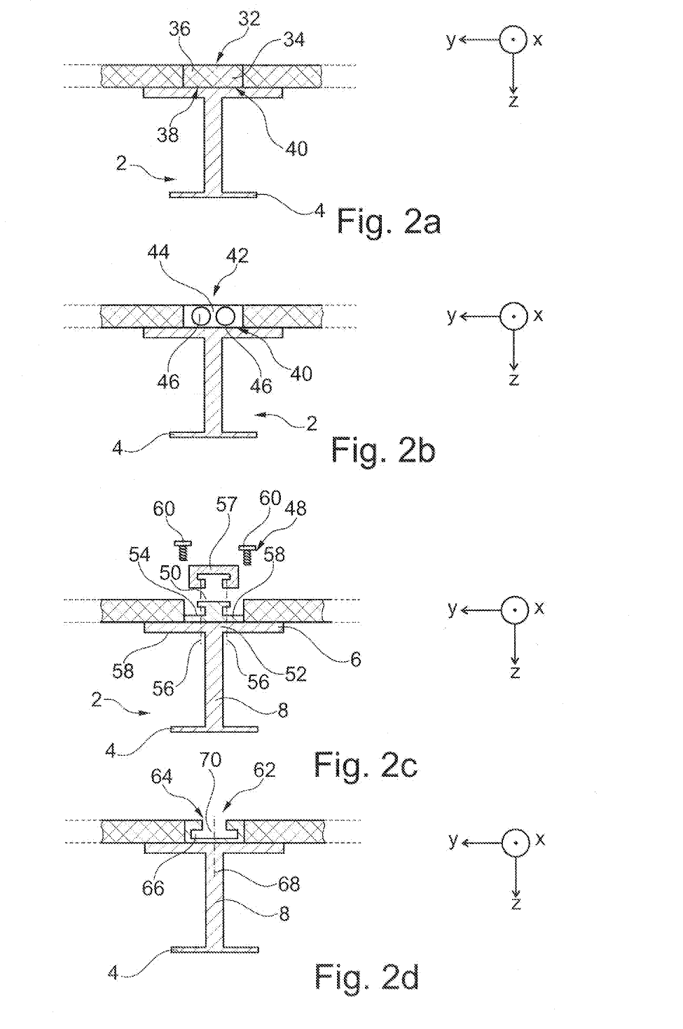

The functional attachment 16 may be realized by different exemplary embodiments, from which some are shown in FIGS. 2a to 2d. FIG. 2a exemplarily shows a floor attachment 32, which is realized as a lightweight component having a honeycomb core 34 and two cover layers 36 and 38 delimiting the honeycomb core 34. By means of a glue layer 40, which is exemplarily realized in form of a double-sided tape, the floor attachment 32 may be positioned on the support bar 2 (or 22).

In FIG. 2b, a raceway attachment 42 is shown, which comprises a hollow space 44, which is designed for receiving and guiding of lines 46. The raceway attachment 42 may be realized in form of an elongate, hollow component, e.g. made from a plastics material. Also, the raceway attachment 42 may be connected to the support bar 2 (or 22) through a glue layer 40.

In the illustrations shown in FIGS. 2a and 2b, the first connection means, which are referred to with “18” in FIG. 1a, are merely receiving surfaces for conducting a glue connection with the glue layer 40.

FIG. 2c shows a glide rail attachment 48 having a gliding body 50 and a bottom side 52, which is arranged on the contacting surface 6 of the support bar 2. The gliding body 50 comprises an undercut 54, which conducts a form-fit with a gliding block 57. Furnishing items are holdable on the gliding block 57, which are then slidable on the glide rail attachment 48.

For connecting the glide rail attachment 48 with the contacting surface 6, screwing connections are conceivable, wherein these should particularly be arranged on lateral sections of the glide rail attachment 48. Exemplarily, first connection means 56 are provided at both sides of the web 8 for this purpose, as well as second connection means 58 on corresponding regions of the bottom side 52. The second connection means 58 may be through-holes, through which the screws 60 are insertable, which are then screwable into an inner thread of the first connection means 56, which are designed as threaded holes.

Finally, FIG. 2d shows a seat rail attachment 62 having a profile penetrated by grid openings as well as a hollow space 66 created therein, which allows insertion and clamping of locking bodies (not shown). The seat rail attachment 62 may also be realized with exemplarily a single first connections means 68 in form of a threaded hole 68 running in the web and a correspondingly arranged through-hole as second connections means 70 in the seat rail attachment 62.

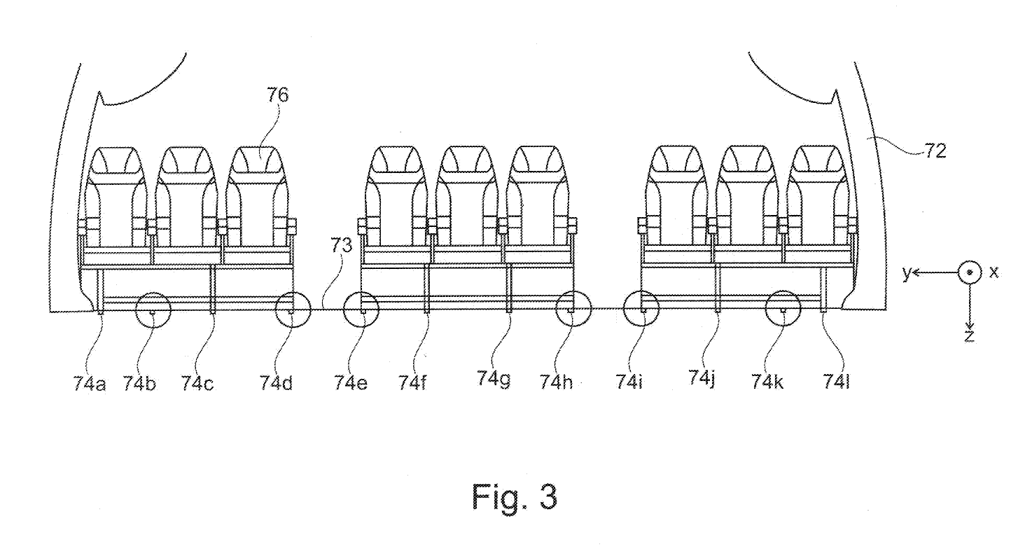

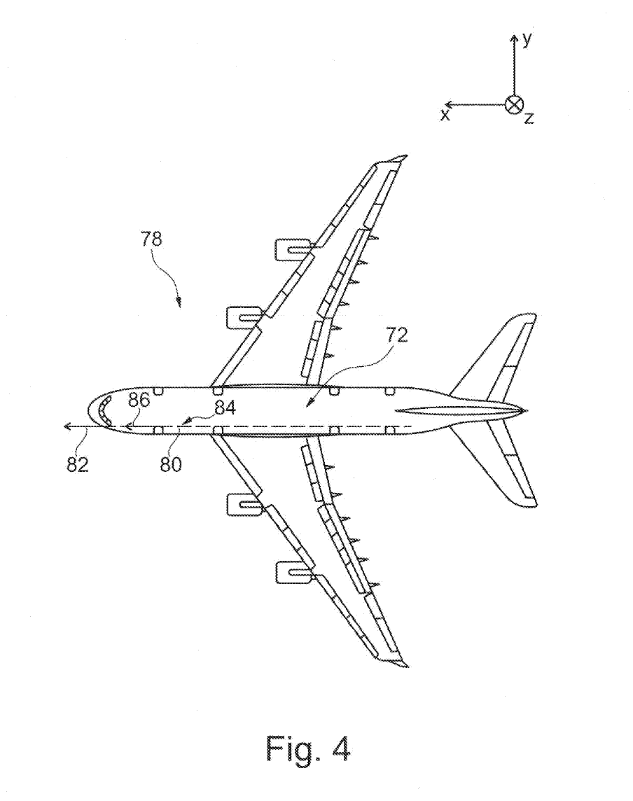

As shown in FIG. 3, a floor 73 of a cabin 72 of an aircraft 78 shown in FIG. 4 may be equipped with a row of twelve support bars 74a, 74b, 74c, . . . , 74l, from which only six support bars 74a, 74c, 74f, 74g, 74j and 74l are in use. At the remaining support bars 74b, 74d, 74e, 74h, 74i and 74k, exemplarily floor attachments 34 may be used, such that the unused support bars 74b, 74d, 74e, 74h, 74i and 74k provide a continuous floor. The support bars 74a, 74c, 74f, 74g, 74j and 74l on the other hand are exemplarily equipped with seat rail attachments 62 or glide rail attachments 48, on which passenger seats 76 may be fastened. Overall, clear weight advantages in comparison to using of common seat rails are achieved. For the sake of completeness it is indicated that the support bars 74a to 74b extend in x-direction, i.e. along a longitudinal axis of the cabin 72.

Finally, FIG. 4 shows an aircraft 78 having a cabin 72 arranged therein and a plurality of support bars, which extend along a first main extension direction 82 on the floor. Exemplarily, here only the first main extension direction 82 of a single support bar 80 is shown. On this exemplarily, a functional attachment 84 is placed, which extends along a second main extension direction 86.

In addition, it should be pointed out that “comprising” does not exclude other elements or steps, and “a” or “an” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

What is claimed is:

1. A rail system for fastening of furnishing items to a floor of a passenger cabin of an aircraft, the rail system comprising:
at least one elongate support bar having a first main extension direction, a base surface in the form of a first flange extending along the first main extension direction for fastening to a vehicle structure, a contact surface extending along the main extension direction at a distance to the base surface and having a first width and first connection means, which are distributed along the first main extension direction at a second flange;
at least one elongate functional attachment having a second main extension direction and a second width, which is equal to the first width at a maximum, and second connection means, which are distributed along the second main extension direction; and
connection elements for connecting the functional attachment to the contacting surface of the support bar;
wherein the first connection means and the second connection means are arranged corresponding with each other in case the first main extension direction and the second main extension direction coincide;
wherein the connection elements are adapted for connecting the first connection means and the second connection means with each other; and
wherein at least the second flange is formed in a surface-like manner.

2. The rail system of claim 1, wherein two surface-like webs, which run parallel to the contacting surface and to each other, are laterally created on the second flange and create lateral guiding edges for delimiting the contacting surface.

3. The rail system of claim 1, wherein the functional attachment is chosen from a group of functional attachments, the group comprising:
a seat rail attachment having a bottom side and a top side, wherein the bottom side is connectable to the contacting surface of the support bar and wherein the top side comprises grid openings at a distance to each other; and
a floor attachment, whose second width substantially equals the first width, wherein the floor attachment is walk-on-able by persons in the cabin.

4. The rail system of claim 3, the group further comprising:
a raceway attachment, which comprises a bottom side and a hollow space defined thereon for receiving and guiding of lines, wherein the bottom side is connectable to the contacting surface of the support bar.

5. The rail system of claim 2, the group further comprising:
a glide rail attachment having a bottom side and a top side, wherein the top side comprises a gliding body, which is adapted for slidably supporting a gliding block along the second main extension direction.

6. The rail system of claim 5, wherein the glide body comprises at least one undercut, which extends along the second main extension direction and which is shaped corresponding to a protrusion of the gliding block.

7. The rail system of claim 1, wherein the contacting surface of the support bar comprises at least one guiding means for aligning the functional attachment.

8. The rail system of claim 7, wherein the at least one guiding means comprises two opposed guiding edges that run along the first main extension direction and that conduct a form-fitting connection with the functional attachment.

9. The rail system of claim 1, wherein the second connection means are designed as through-holes.

10. The rail system of claim 9, wherein the first connection means comprises boreholes, which have an inner thread, into which connection elements having an outer thread are screwable, which are inserted through the second connection means.

11. The rail system of claim 1, wherein the at least one functional attachment is made from another material than the support bar.

12. An aircraft comprising:
an aircraft structure;
a passenger cabin having a floor;
a plurality of support bars, which are arranged on a plurality of support bars that are arranged in a section of the vehicle structure that supports the floor; and
functional attachments mounted on the support bars;
wherein the support bars and the functional attachments are created by a rail system according to claim 1; and
wherein the functional attachments substantially close-off flushly with an adjacent floor.
